(19) United States
(12) Patent Application Publication
(10) Pub. No.: US 2003/0136729 A1
(43) Pub. Date: Jul. 24, 2003

(54) Separators

(75) Inventor: Richard Guy Batson, Sedgefield (ZA)

Correspondence Address: MERCHANT & GOULD PC, P.O. BOX 2903, MINNEAPOLIS, MN, 55402-0903, US

(73) Assignee: WATER MINERALS LIMITED, ST. PETER PORT (GB)

(21) Appl. No.: 10/349,012

(22) Filed: Jan. 21, 2003

Related U.S. Application Data
(63) Continuation of application No. PCT/IB01/01330, filed on Jul. 25, 2001.

(30) Foreign Application Priority Data
Jul. 25, 2000 (ZA) 2000/3744

(51) Int. Cl. B01D 21/26

(52) U.S. Cl. 210/512.1; 210/512.2

(57) ABSTRACT

A separation component for a separator includes a truncated hollow conical separation member having an operatively upper inclined separation surface and an operatively lower inclined separation surface, and a plurality of spacers protruding from, and extending along, one of the separation surfaces of the separation member. The spacers are spaced apart about the separation member A valley is defined between each spacer and the separation surface and provides a pathway along which, in use, solids can pass. The angles at which the pathways are inclined to the horizontal are less than the angle at which the separation surface is inclined to the horizontal.

THIS INVENTION relates to separators. It relates also to a separation component and to a separation component stack for a separator.

According to a first aspect of the invention, there is provided a separation component for a separator, the separation component including

a truncated hollow conical separation member having an operatively upper inclined separation surface and an operatively lower inclined separation surface; and

a plurality of spacers protruding from, and extending along, one of the separation surfaces of the separation member, the spacers being spaced apart about the separation member, with a valley being defined between each spacer and the separation surface and providing a pathway along which, in use, solids can pass, and with the angles at which the pathways are inclined to the horizontal being less than the angle at which the separation surface is inclined to the horizontal.

The angle at which the separation surface from which the spacers protrude is inclined to the horizontal, may be from 20° to 80°, typically from 45° to 70°.

The spacers will normally extend the full distance between ends of the separation member, ie from an operatively lower end or edge of the separation member to an operatively upper end or edge; however, if desired, each spacer may comprise at least two aligned portions whose ends are spaced apart, ie they may be discontinuous.

Each spacer may be in the form of a strip whose thickness is substantially less than its width, ie the distance it protrudes from the separation surface. Typically, the thickness of each spacer may be from 2 mm to 5 mm, while its width may typically be from 10 mm to 50 mm. The spacers may protrude perpendicularly from the separation surface.

The spacers may be spaced equidistantly apart about the separation member. Typically, between 6 and 12 spacers may be provided.

The spacers may be arranged such that the angle at which the pathway of each spacer is inclined to the horizontal has a constant set value along the entire length of the spacer. The valley pathways or lines representing the intersections or joinings of the spacers with the separation surface may thus take the form of helical spirals, or at least partial helical spirals. However, instead, the spacers may be arranged such that the angles at which the pathways are inclined to the horizontal vary along the lengths of the spacers.

The spacers can thus slope upwardly either to the left or to the right, when the separation component is viewed in elevation with its axis upright, eg vertical, and its base, ie its end having the largest diameter, lowermost. In other words, when the separation component is viewed from the top, the spacers spiral or turn in either a clockwise or an anticlockwise sense from the base of the separation component to its top. Hereinafter, a separation component whose spacers turn in a clockwise direction when viewed as described above, is termed a ‘clockwise separation component’ while a separation component whose spacers turn in an anticlockwise direction when thus viewed, is termed an ‘anticlockwise separation component’. It will be appreciated that all the spacers will normally turn in either the clockwise or the anticlockwise direction.

According to a second aspect of the invention, there is provided a separation component stack, which includes a plurality of separation components each comprising a truncated hollow conical separation member having an operatively upper inclined separation surface and an operatively lower inclined separation surface, and a plurality of spacers protruding from, and extending along, one of the separation surfaces of the separation member, the spacers being spaced apart about the separation member, with a valley being defined between each spacer and the separation surface and providing a pathway along which, in use, solids can pass, and with the angles at which the pathways are inclined to the horizontal being less than the angle at which the separation surface is inclined to the horizontal, the separation components being located one inside the other so that the spacers of one separation component abut an unencumbered separation surface of an adjacent separation component, the separation members thereby providing an array of parallel inclined separation surfaces.

By ‘unencumbered separation surface’ is meant that separation surface of a separation component which is not provided with the spacers, ie the spacer-free separation surface of the separation component.

The separation surfaces of the separation components, and the spacers of each separation component, may be as hereinbefore described with reference to the first aspect of the invention.

According to a third aspect of the invention, there is provided a separator, which includes

a normally upright vessel having a feed inlet zone;

at least one separation component stack, which includes a plurality of separation components each comprising a truncated hollow conical separation member having an operatively upper inclined separation surface and an operatively lower inclined separation surface, and a plurality of spacers protruding from, and extending along, one of the separation surfaces of the separation member, the spacers being spaced apart about the separation member, with a valley being defined between each spacer and the separation surface and providing a pathway along which, in use, solids can pass, and with the angles at which the pathways are inclined to the horizontal being less than the angle at which the separation surface is inclined to the horizontal, the separation components being located one inside the other so that the spacers of one separation component abut an unencumbered separation surface of an adjacent separation component, the separation members thereby providing an array of parallel inclined separation surfaces, inside the vessel; and

a heavy fraction outlet leading from the vessel below the stack, when the vessel is upright, with the outlet and the separation component stack being arranged such that a feed suspension or mixture which enters the feed inlet zone passes between the separation members and between the spacers located between adjacent pairs of separation members, with separation of the feed suspension or mixture into a light fraction and a heavy fraction taking place under gravity as the suspension or mixture passes between the separation members, and with the light fraction moving upwardly while the heavier fraction moves downwardly and is withdrawn through the heavy fraction outlet.

The separator may include a light fraction outlet leading from the vessel above the stack, when the vessel is upright. Such a light fraction outlet will be provided when the light fraction which is produced, flows freely. The light fraction outlet can, however, be omitted when the light fraction which is produced does not flow freely. In such case, the separator may include scraper or scooping means for scraping or scooping the light fraction from the surface of the liquid contained in the vessel.

The spacers of each separation component serve to space adjacent separation members apart, to impart rigidity to the separation member to which they are attached, and to bear the weight of superior separation components. The separation members may be of non-apertured or imperforate, ie continuous, form so that solids and liquid passing along the separation surfaces cannot pass through the individual separation members. However, instead, apertures or slots may be provided in at least some of the separation members to permit passage of liquid and/or solids, as the suspension or mixture passes along the separation surfaces.

The stack may be arranged such that, when the vessel is upright, the axes of the separation members are vertical. The separation members can be arranged with their truncated apices directed either upwardly or downwardly, as hereinafter described.

The separation surfaces of the separation components of the stack, and the spacers of each component, may be as hereinbefore described with reference to the first aspect of the invention.

Thus, as hereinbefore described, in respect of each separation component, the spacers may be arranged such that the angle at which the pathway of each spacer is inclined to the horizontal has a constant set value along the length of the spacer, with the pathways thus being in the form of at least partial helical spirals.

The separation components may, in particular, be arranged so that, in the stack, clockwise separation components alternate with anticlockwise separation components. The spacers of one separation component will thus cross the spacers of an adjacent separation component at an angle. As hereinbefore indicated, while typically between 6 and 12 spacers may be provided on each separation component, in practice a sufficient number of spacers will be provided so that each spacer of a separation component bears, through a separation member, on at least one spacer of the separation component immediately below it, irrespective of the angular locations of the separation components.

The separation components preferably are located loosely one within the other. In other words, they preferably are not attached or secured together. This will permit the separation components to move, eg be lifted, relative to one another, such as in the event of a sludge build-up in the vessel, thereby preventing or inhibiting damage to the separation members.

By locating, within the stack, clockwise separation components and anticlockwise separation components in alternate fashion, it is not necessary for a separation component to be located in a set angular position relative to an adjacent separation component, in order to ensure that the weight of a superior separation component is taken directly through the spacers of the separation component immediately below it, and that there are no forces acting on the separation members themselves which could cause them to bend or distort. This also implies that, should the separation components move during operation or maintenance, it is not necessary to realign the separation components.

In practice, it is preferably to provide a sufficient number of spacers in each separation component to ensure that each spacer bears, through a separation member, on at least two spacers of an adjacent separation component, irrespective of the relative angular location of the adjacent separation components. This thus means that each spacer is supported in at least two places along its length, obviating any tendency for it to tilt and distort the separation member to which it is attached.

The separation members may all be of the same size so that they are stacked vertically with one separation component bearing the weight of all the superior separation components above it. However, instead, the separation members may be of differing sizes so that they are located one inside the other in a horizontal sense, with the spacers thus serving to space adjacent separation members apart, to provide rigidity, and to provide bearing for the weight of the inner separation components. Still further, the separation component may be stacked partly vertically and partly horizontally.

The angle at which the pathways should be inclined to the horizontal can be determined for each particular feed suspension or mixture, and is the minimum angle at which any solids in the feed suspension will slide down or up the pathway, as the case may be, when the solids have separated from the liquid fraction in the suspension, under gravity. In practice, when the pathway angle has been determined for a particular feed suspension, it will normally be able to handle substantial variations in the feed suspension such as variations in concentration, etc.

As indicated hereinbefore, while the angle that the pathways make with the horizontal will normally, for a particular application, have a constant set value, it may vary along the lengths of the spacers. It is believed that this configuration could be advantageous where, for example, the solids fraction consists of a mixture of materials with different frictional characteristics, with the different components separating out at different locations along the pathways or intersection lines.

The vessel may comprise a normally vertically upright cylindrical wall, and an inverted hollow conical bottom depending from a lower peripheral edge of the wall, with the heavy fraction outlet being provided at the apex of the conical bottom. The separation members may be located concentrically inside the vessel, within the wall and/or the bottom. Alternatively, more than one separation component stack may be located inside the vessel, with the stacks generally being located at the same level and being spaced within the vessel. The vessel may be closed off, eg in order to operate under pressure.

The separation component stack may be supported in any suitable fashion or by any suitable means. Thus, for example, the lowermost separation component may be fixed within the vessel, such as by forming part of the vessel or being a separate component attached to the wall or bottom of the vessel. Another alternative is for the lowermost separation component to be supported at its apex from an elongate support member such as a rod or pipe, which passes through the stack and ends with a hook or shackle. The stack is then free to swing from such hook or shackle, which can be advantageous should the vessel fill with solids which become very stiff and which would otherwise bridge across from the wall or bottom of the vessel to the separation component stack.

The separators according to the invention can be used to perform different separations:

Type 1 Separation:

This involves the separation of heavy solid particles from a fluid, which can be a liquid or a gas, which has a lower density than the solids.

Type 2 Separation:

This involves the separation of light solid particles from a liquid which has a higher density than the solid particles. An example of Type 2 separation is dissolved air flotation. In dissolved air flotation, the actual density of the solids can be greater or equal to that of the liquid; however, minute bubbles of air or another gas are arranged to contact the surfaces of the solids so that the overall average density or effective density of the solids plus attached gas bubbles, is less than that of the liquid. Another example is the separation of granular or powdered polyethylene, which has an S.G. of less than 1, from water.

Type 3 Separation:

This involves the separation of two liquids of different densities and where the liquids are not mutually soluble.

Type 4 Separation:

This involves the separation of a suspension into two components, based upon the difference in density and/or effective size of the solid components in the suspension.

For Type 1 separation, the separation members in the separation component stack are arranged such that separated solids can slide downwardly along the upper separation surfaces of the separation members, and hence also along the pathways. The feed suspension comprising solid particles suspended in a liquid, can be arranged to enter between the separation members at a low or a high level, with the liquid fraction moving between the separation members with an upward component of velocity. Thus, as the feed suspension passes between the separation members, guided by the spacers, solids separate out from the suspension under gravity. The inclinations of the separation members and the spacers are such that the separated solids slide along the separation surfaces of the separation members until they either exit from the stack of separation components, or encounter the nearest spacer. In such case, the solids will continue to slide along the pathway or line representing the intersection between the separation surface of the separation member and the spacer, since the true angle that this line or the valley makes with the horizontal is equal to or higher than the critical angle at which the solids will continue to slide along the pathway. Separated solids, together with some liquid, collect in the bottom of the vessel, for withdrawal through the heavy fraction outlet. The major portion of the liquid fraction normally exits the vessel through the higher light fraction outlet.

In Type 2 separation, the inclination of the separation components is arranged such that separated solids can slide upwardly along the lower separation surfaces of the separation members until they either exit from the stack of separation components, or encounter the nearest spacer. In such case, the solids will continue to slide along the pathway or line representing the intersection between the separation surface of the separation member and the spacer, since the true angle that this line or the valley makes with the horizontal is equal to or higher than the critical angle at which the solids will continue to slide along the pathway. In this case, the feed suspension is normally arranged to enter between adjacent separation members at a high level, with the liquid fraction moving between the separation members with a downward component of velocity. The light solids rise to the top of the vessel to exit, together with some of the liquid fraction, through the light fraction outlet, or, alternatively, are scraped from the surface of the liquid. The major portion of the liquid fraction normally exits the vessel through the heavy fraction outlet. The mechanism of the separation is similar to that for Type 1 separation hereinbefore described.

In Type 3 separation, where the feed is a mixture of two liquids of different densities, the feed can enter between the separation members at a high level or at a low level. When separating a mixture of two liquids of different densities, the inclination of the pathways is normally not critical, and may typically be set at 45° to the horizontal. The liquid with the lower density will exit through the light fraction outlet, while the liquid with the higher density will exit through the heavy fraction outlet.

In Type 4 separation, involving the separation of a suspension into two components, based on the difference in density and/or effective size of the solid components in the suspension, and which is normally referred to as classification, the feed enters between the separation members at a high level or at a low level. The denser and/or larger particles, together with some of the carrier liquid, will exit the vessel through the heavy fraction outlet, while the less dense and/or smaller particles will exit the vessel, normally with the majority of the carrier liquid, through the light fraction outlet.

The invention will now be described by way of example, with reference to the accompanying diagrammatic drawings.

In the drawings,

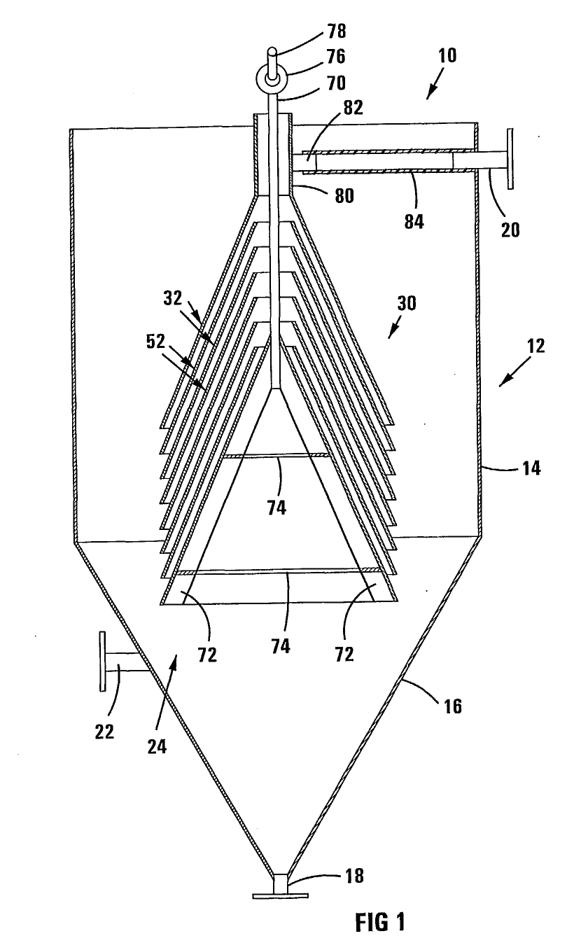

FIG. 1 shows a longitudinal axial sectional view of a separator according to the first embodiment of the invention, with some details omitted;

FIG. 2 shows a side view of a clockwise separation component of the separation component stack in FIG. 1;

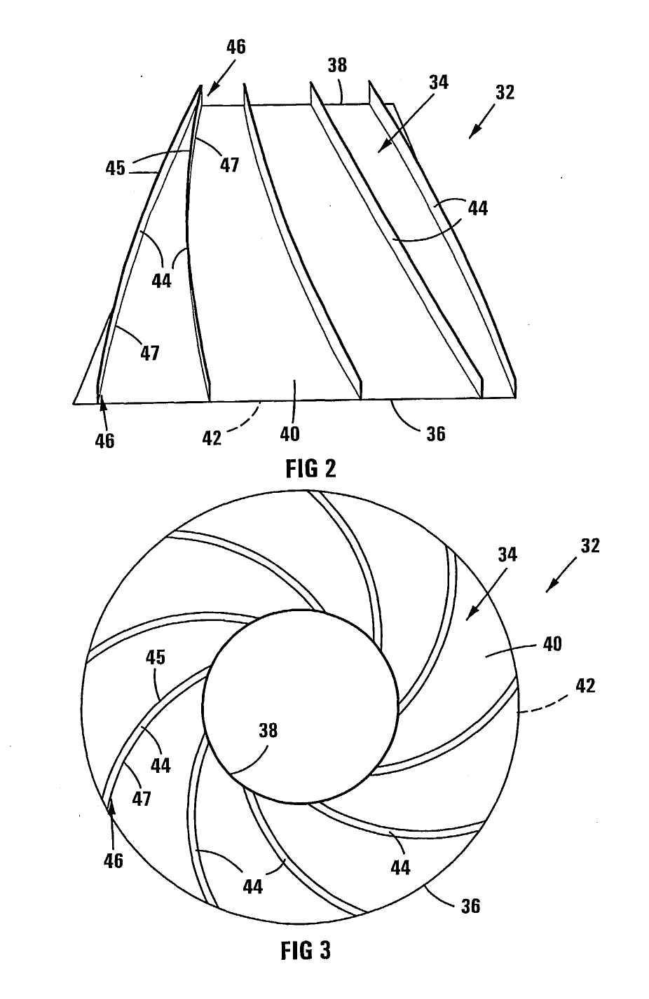

FIG. 3 shows a plan view of the clockwise separation component of FIG. 2;

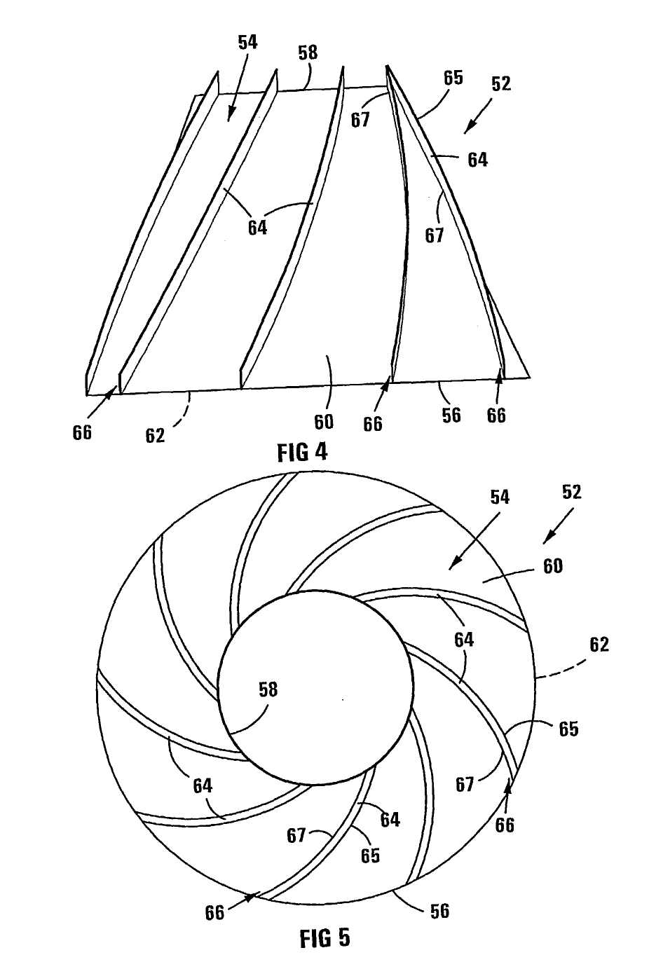

FIG. 4 shows a side view of an anticlockwise separation component of the separation component stack in FIG. 1;

FIG. 5 shows a plan view of the anticlockwise separation component of FIG. 4;

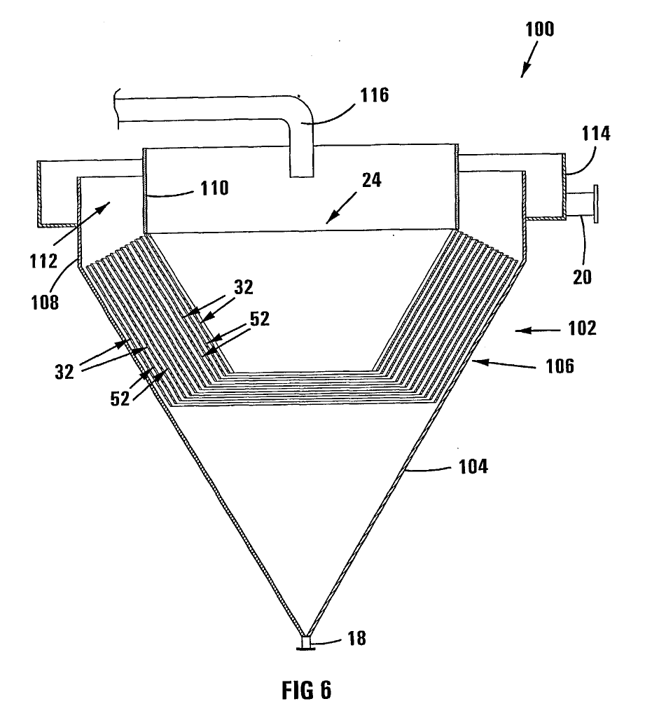

FIG. 6 shows a longitudinal axial sectional view of a separator according to a second embodiment of the invention, with some details omitted;

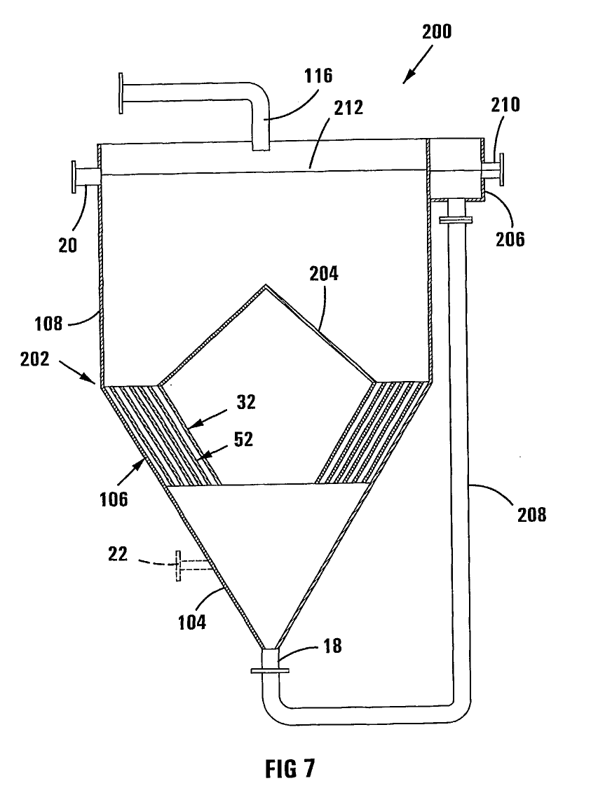

FIG. 7 shows a longitudinal axial sectional view of a separator according to a third embodiment of the invention, with some details omitted; and

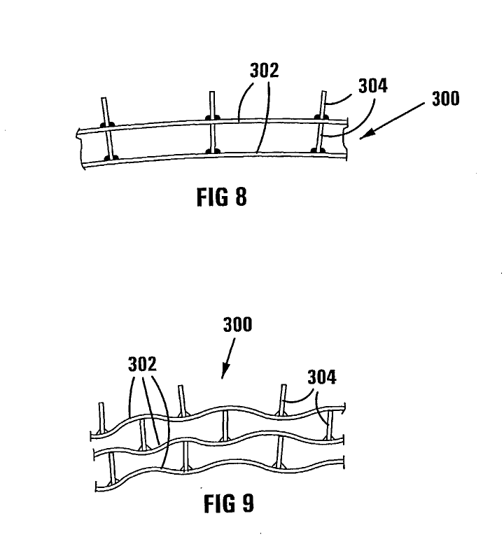

FIGS. 8 and 9 show, in part, sectional views of a known parallel plate separator having vertical spacers between its plates, with FIG. 8 showing the vertical spacers aligned with one another, and with FIG. 9 showing the vertical spacers staggered with respect to one another.

Referring to FIGS. 1 to 5, reference numeral 10 generally indicates a separator or settler according to a first embodiment of the invention.

The separator 10 includes an upright vessel, generally indicated by reference numeral 12. The vessel 12 includes a vertically upright circular cylindrical wall 14, and a hollow conical bottom 16 depending from the lower peripheral edge of the wall 14. A heavy fraction or sludge outlet 18 is provided at the apex of the bottom 16. The vessel 12 is supported on a support structure (not shown). A light fraction or overflow outlet 20 is provided in the vessel wall 14, near its upper end.

A feed inlet 22, for feeding a feed suspension into a feed zone 24 of the vessel 12, is also provided.

A separation component stack or array, generally indicated by reference numeral 30, is located mainly within the cylindrical wall 14 of the vessel 12. The array or stack 30 comprises a plurality of hollow truncated conical separation components 32, 52 loosely located or nested one within the other, and spaced vertically apart. The separation components 32 are clockwise separation components, as hereinafter described, while the separation components 52 are anticlockwise separation components, as also hereinafter described. In the stack or array 30, the clockwise separation components 32 and the anticlockwise separation components 52 are arranged in alternating fashion. Thus, apart from the uppermost separation component and the lowermost separation component, each clockwise separation component 32 is sandwiched between two anticlockwise separation components, while each anticlockwise separation component 52 is sandwiched between two clockwise separation components 32.

Each clockwise separation component 32 comprises a hollow truncated conical separation member 34 having a lower end or base 36 and an upper end 38 which is thus of smaller diameter than the base 36. The separation member 34 has an upper separation surface 40, as well as a lower separation surface 42.

From the upper separation surface 40 protrudes a plurality of elongate spacers 44. Each spacer 44 extends from the base 36 to the upper end 38 of the separation member 34, and is in the form of a strip protruding from the separation surface 40. The thickness of each strip is typically in the order of about 3 mm, while the width of the strip, ie the height that the strip protrudes from the surface 40, is typically about 30 mm. Each spacer 44 is mounted perpendicularly to the surface 40, and has an upper edge 45 which is spaced from the surface 40. A valley, generally indicated by reference numeral 46, is defined between each spacer 44 and the separation surface 40. Each valley 46 provides a pathway 47, ie a line 47 representing the intersection or joining of the spacer 44 with the separation surface 40. Each spacer 44 is curved, ie it does not extend radially or in a straight line from the base 36 to the upper end 38 of the separation member 34. In particular, each spacer 44 is arranged such that the angle of the pathway or line 47 has a constant set value along the entire length of the spacer. In other words, the pathway angle or the true angle that the line of intersection of the spacer with the separation surface makes with the horizontal, is a constant set value along the length of the spacer. Thus, the pathway 47, ie the line representing the intersection of the spacer 44 with the separation surface 40, is in the form of a partial helical spiral.

The spacers 44 slope upwardly to the left when the separation component is viewed in elevation, as seen in FIG. 2. In other words, when the separation component 32 is viewed from the top (FIG. 3), the spacers 44 spiral or turn in a clockwise sense from the base 36 of the separation component 32 to its upper edge or end 38.

Each of the separation components 52 has a truncated hollow conical separation member 54 having a base 56 and an upper end 58, as well as an upper separation surface 60 and a lower separation surface 62. Each separation component 52 also has a plurality of spacers 64 defining valleys 66 with the separation surface 60. Each valley 66 provides a pathway 67. The pathways 67 are thus similar to the pathways 47 of the separation components 32. The spacers 64 have upper edges 65.

The separation components 52 are similar to the separation components 32 as regards their spacers etc, save that the spacers, when the separation component is viewed in elevation (FIG. 4) slope upwardly to the right. In other words, when the separation components 52 are viewed from the top (FIG. 5), the spacers 64 spiral or turn in an anticlockwise sense from the base 56 of the separation component 52 to its upper edge or end 58.

The stack 30 also includes a central support pipe 70, with the lowermost separation component 32, 52 being attached to the lower end of the pipe 70, eg by means of welding. The lowermost support component is provided with a plurality of spaced elongate stiffeners 72, as well as stiffening rings 74.

The upper end of the pipe 70 is provided with a ring 76 which is suspended from a support 78.

All the separation components 32, 52 are thus supported on the lowermost support components 32, 52, with one support component located or nested within the other. The spacers 44, 64 serve to space adjacent separation members apart, to carry the weight of superior separation components, and impart rigidity to the separation members. In particular, each spacer is supported by at least two spacers, in zones of cross-over, of the support component below it, through the separation member of the separation component below it. In other words, each spacer 44, 64 is supported in at least two places along its length, thereby obviating any tendency for it to tilt and to distort the separation member to which it is attached.

The entire stack 30 can pivot or move relative to the vessel 12, by means of the ring 76.

All the separation members 34, 54 are of the same size. Thus, the separation components 32, 52 are spaced vertically apart, with their bases 36, 56 all having the same horizontal projection.

A tubular component 80 protrudes upwardly from the upper end of the uppermost separation member, and is provided with an outlet connection 82. A flexible tube or conduit 84 connects the connection 82 to the light fraction outlet 20.

Thus, in the stack 30, the separation members 34, 54 extend parallel to each other and provide parallel inclined separation surfaces. The angle of inclination of the upper and lower separation surfaces of the separation members to the horizontal is 60°.

In the stack 30, each separation component 32, 52, is free to rotate relative to the vessel 12, as well as relative to adjacent separation components, and can also lift relative to adjacent components.

In use, a suspension of heavy particulate matter in a lighter liquid, eg a suspension of mineral bearing rock in water, is fed into the vessel 12 through the inlet 22, ie is fed into the feed zone 24. The suspension moves upwardly, and enters the spaces between adjacent separation members 34, 54. The suspension thus moves upwardly between the separation components 32, 52. As the suspension moves upwardly between the separation components, solid particles separate out on the upper separation surfaces 40, 60 of the separation members, while clarified water moves upwardly along the spacers 44, 64 between the adjacent separation components into the annular space defined, around the pipe 70, by the upper truncated ends 38, 58 of the separation members. From there, the clarified water passes through the connection 82, along the conduit 84, and out of the vessel 12 through the light fraction outlet 20.

When sufficient solid particles have gathered on the upper separation surfaces of the separation members, they slough off and collect in a collection zone defined by the bottom 16 of the vessel 12. From time to time, or continuously, as required, sludge is then withdrawn through the outlet 18.

In the event that there should be excess sludge build-up in the vessel 12 so that the sludge reaches the level of the stack 30, the upward forces exerted by the sludge will serve to lift the separation components 32, 52 upwardly since they merely rest on the lowermost fixed separation component. This will prevent damage to the separation components 32, 52. The stack can also pivot and move sideways by means of the ring 76, thereby preventing the bridging of stiff solids between the stack and the wall of the vessel.

The separator or settler 10 is suitable for Type 1 and Type 4 separations.

### EXAMPLE

The separator 10, but in the form of a closed, pressurized vessel, was used for the separation of precipitated calcium sulphate anhydrite from treated water at temperatures of about 150° C. and pressures of 500-600 kPa(g).

The vessel 12 of the separator 10 was constructed in mild steel, 6 mm thick, and had a diameter of 800 mm. The separation component stack 30 had a diameter of 600 mm, with the separation members 34, 54 of the separation components 32, 52 being of 2 mm thick mild steel, while the spacers 44, 64 were of 3 mm thick mild steel.

The results obtained were as shown in Table 1.

TABLE 1

| | | Sulphate | Calcium |
|---|---|---|---|
| | | concentration in | concentration in |
| Feed sulphate- | Precipitation | treated water- | treated water- |
| mg/l | Temperature-° C. | mg/l | mg/l |
| 950 | 151 | 190 | 77 |
| 1100 | 155 | 170 | 70 |
| 1050 | 160 | 150 | 58 |
| 1050 | 162 | 140 | 55 |
| 1100 | 150 | 200 | 80 |
| 1100 | 161 | 145 | 60 |

The carry-over of precipitated calcium sulphate anhydrite was in the range of 5-10 mg/l. There was no distortion of the separation components 32, 52.

Referring to FIG. 6, reference numeral 100 generally indicates a separator according to a second embodiment of the invention.

Parts of the separator 100 which are the same or similar to those of the separator 10, are indicated with the same reference numerals.

The separator 100 includes a vessel, generally indicated by reference numeral 102. The vessel 102 has a conical wall 104 having, at its apex, the outlet 18.

A separation component stack, generally indicated by reference numeral 106, is provided within the vessel wall 104, at its upper end. The stack 106 is similar to the stack 30 and thus comprises separation components 32, 52, except that its separation components 32, 52 are inverted. The stack 106 is supported by the wall 104 at the upper end of the wall 104.

A skirt or side wall 108 protrudes upwardly from the upper peripheral edge of the wall 104, while a similar skirt 110 protrudes upwardly from the upper peripheral edge of the innermost separation component 32 or 52. An annular settled water or light fraction chamber 112 is provided between the skirts 108, 110. An annular overflow launder 114 is provided around the upper end of the skirt 108, with the light fraction or overflow outlet 20 leading from the launder 114. A feed conduit 116 is arranged so as to introduce feed suspension into the centre of the skirt 110. The feed zone 24 is thus located at a high level above the stack 106, but also extends downwardly and below the separation component separation stack 106.

In use, a suspension, similar to that hereinbefore described with reference to FIGS. 1 to 5, is introduced into the feed zone 24. The suspension passes, as in the case of the settler 10, upwardly between the separation components 32, 52 so that the settler 100 functions in substantially the same fashion as the settler 10. Clarified water collects in the chamber 112, flows over the top of the skirt 108 which may be equipped with adjustable weir plates (not shown), and then passes through the outlet 20 via the launder 114. Sludge is withdrawn through the outlet 18 as in the case of the settler 10.

The separator or settler 100 is suitable for Type 1 or Type 4 separations.

Referring to FIG. 7, reference numeral 200 generally indicates a separator according to a third embodiment of the invention.

Parts of the separator 200 which are the same or similar to those of the separators 10, 100 hereinbefore described, are indicated with the same referenced numerals. As indicated in broken line, the feed inlet 22 can instead be provided in the wall 104. The feed inlet 22 will then replace the feed conduit 116.

The separator 200 includes a separation component stack 106 which is similar to that of the separator 100, and which is located inside a vessel 202. However, the upper end of the innermost separation component 32 or 52 is closed off by means of a conical component 204. Thus, in use, feed suspension which enters through the feed conduit 116, passes downwardly between the preparation components 32, 52, with heavier liquid collecting at the bottom of the vessel 202, while any of the lighter fraction, initially entrained in the heavy fraction, separates from such heavy fraction in the tranquil conditions existing between the separation components and then passes upwardly along the separation surfaces and collects within the skirt 108 to be withdrawn through the outlet 20. Light solids, represented by reference numeral 212, floating on the surface of the liquid in the vessel 202 may, alternatively, be scraped or scooped from the surface of the liquid.

In the separator 200, the heavy fraction outlet 18 is connected to a constant head box 206 by means of a conduit 208, with a heavy fraction overflow outlet 210 leading from the box 206.

The separator 200 is suitable for Type 2 and Type 3 separations.

Separators or settlers are designed, in general, not to remove all the solids from a feed suspension, but to remove those solids, or flocculated solids, which have settling velocities greater than a certain value. This settling velocity is dependent on the density of the solid particles or flocs relative to the density of the liquid, the size and shape factor of the particles or flocs, the viscosity of the liquid fraction and the solids volume fraction, ie that fraction of the volume of the suspension occupied by the particles or flocs. In most cases this means that particles or flocs above a certain size, ie above the cut-off size, will be trapped by the settler, while those smaller than that size will be carried over with the liquid.

In a parallel plate or parallel cone settler, when used for Type 1 separation where the solids are heavier than the carrier liquid, the design feed suspension flow rate depends on the length of the flow path between the plates or cones, ie between the separation members, and the vertical distance between the separation members. If all the flow path lengths are not equal, or if the gap between the separation members varies, then the settler will not provide a single cut-off size and the settler overflow will contain some large particles or flocs which should have reported to the underflow, while the underflow will contain small particles or flocs which should have been carried over in the overflow, ie in the light fraction.

It is therefore essential to ensure that not only are all alternative flow paths of equal length, but that the gaps between the separation members are as uniform as possible.

Similar reasoning applies to Type 2, Type 3 and Type 4 separations, where variations in the flow path lengths or the gaps between the separation members or cones lead to inefficiencies in the separation process in that the cut between the two fractions is not precise.

This is achieved in the present invention by the use of the spacers 44, 64 which set and maintain the gap between adjacent separation members. The direction of flow of the suspension is guided by the spacers. Rigidly attaching the spacers to the separation members, eg by welding, stiffens the separation members both radially and circumferentially, so that the thickness of the materials of construction of the separating members can be reduced.

In the separators 10, 100, 200, each separation member 34, 54 is supported by the spacers 44, 64 of an adjacent separation component, with each spacer, through the adjacent separation member, being in contact with at least one, and preferably with at least two, spacers on the adjacent separation member.

In FIGS. 8 and 9, reference numeral 300 generally indicates a known parallel plate separator having a plurality of vertically spaced separation members in the form of conical plates 302 which rest on one another by means of spacers 304 which are attached to one of the surfaces of the plates.

When the plates 302 rest on one another as shown in FIGS. 8 and 9, then loads are thereby imparted to the lowermost separation members, through the radial spacers 304. If the radial spacers are not exactly vertically aligned, these loads tend to circumferentially bend or distort the lowermost plates. FIG. 8 thus shows the spacers 304 vertically aligned with loads taken directly through the spacers, whereas FIG. 9 shows the distortion of the plates 302 when the radial spacers 304 are not vertically aligned. It can readily be seen that such distortion or bending of the plates 302 results in variations in the gaps between the plates.

The Applicant believes that, by virtue of the strengthening of the separation members 34, 54 by the spacers 44, 64 and the lack of distortion of the separation members, since all superimposed loads are taken through the spacers, much larger separation members may be used with much smaller gaps between the separation members. This greatly extends the range of practical applications of parallel cone separators. Thus, the separators can be used for the separation of very fine solids from liquids; liquids which have very similar densities can be separated; and classifications can be carried out at very fine cuts. Alternatively and additionally, parallel separation member or cone stacks according to the invention can operate at much higher feed flow rates than parallel plate or parallel cone separators built according to the prior art.

Normally, the separation members of parallel plate or cone separators are manufactured from PVC, ABS, fibreglass or other materials which are lightweight and corrosion resistant, but not very strong. In Type 1 separation, if the separated solids are not withdrawn at the correct rate from the heavy fraction outlet leading from the vessel at a low level, the slurry of heavy-solids will tend to rise in the conical bottom of the settler. This slurry, over a period of time, can compact to a high density. If the slurry is allowed to reach the separation members and if those members are not very strong, then the forces created by the slurry can break the plate or cone pack. In the present invention, this risk is greatly reduced by the method of assembling the cone plate stack, in that the individual separating members are not tied together, nor is the cone stack tied down or tightly sealed. In other words, the separation members can move relative to each other and relative to the vessel.

1. A separation component for a separator, the separation component including
a truncated hollow conical separation member having an operatively upper inclined separation surface and an operatively lower inclined separation surface; and
a plurality of spacers protruding from, and extending along, one of the separation surfaces of the separation member, the spacers being spaced apart about the separation member, with a valley being defined between each spacer and the separation surface and providing a pathway along which, in use, solids can pass, and with the angles at which the pathways are inclined to the horizontal being less than the angle at which the separation surface is inclined to the horizontal.

2. A separation component according to claim 1, wherein the angle at which the separation surface from which the spacers protrude is inclined to the horizontal is from 20° to 80°, and wherein the spacers extend from a top edge to a bottom edge of the separation member.

3. A separation component according to claim 2, wherein each spacer is in the form of a strip whose thickness is less than the distance it protrudes from the separation surface, and wherein the spacers protrude perpendicularly from the separation surface.

4. A separation component according to any one of claims 1 to 3 inclusive, wherein the spacers are arranged such that the angle at which the pathway of each spacer is inclined to the horizontal has a constant set value along the length of the spacer, with the pathways thus being in the form of at least partial helical spirals.

5. A separation component stack, which includes a plurality of separation components each comprising a truncated hollow conical separation member having an operatively upper inclined separation surface and an operatively lower inclined separation surface, and a plurality of spacers protruding from, and extending along, one of the separation surfaces of the separation member, the spacers being spaced apart about the separation member, with a valley being defined between each spacer and the separation surface and providing a pathway along which, in use, solids can pass, and with the angles at which the pathways are inclined to the horizontal being less than the angle at which the separation surface is inclined to the horizontal, the separation components being located one inside the other so that the spacers of one separation component abut an unencumbered separation surface of an adjacent separation component, the separation members thereby providing an array of parallel inclined separation surfaces.

6. A separation component stack according to claim 5, wherein the angle at which the separation surfaces of the separation components are inclined to the horizontal is from 20° to 80° and wherein the spacers of each separation component extend from a top edge to a bottom edge of the separation member.

7. A separation component stack according to claim 6, wherein each spacer is in the form of a strip whose thickness is less than the distance it protrudes from the separation surface, and wherein the spacers protrude perpendicularly from the separation surface.

8. A separation component stack according to any one of claims 5 to 7 inclusive wherein, in respect of each separation component, the spacers are arranged such that the angle at which the pathway of each spacer is inclined to the horizontal has a constant set value along the length of the spacer, with the pathways thus being in the form of at least partial helical spirals.

9. A separation component stack according to claim 8, wherein the separation components are arranged so that the spacers of alternate separation components slope upwardly to the left, when the separation components are viewed in elevation with their axes vertical and their bases, or ends having the largest diameter, lowermost, and with the spacers of the separation components located between said alternate separation components sloping upwards to the right so that the spacers of one separation component cross the spacers of an adjacent separation component at an angle.

10. A separation component stack according to claim 9, wherein each separation component is provided with a sufficient number of spacers, spaced equidistantly about the separation member, so that each spacer of a separation component bears, through a separation member, on at least one spacer of the separation component immediately below it, irrespective of the angular locations of the separation components.

11. A separator, which includes
a normally upright vessel having a feed inlet zone;
at least one separation component stack, which includes a plurality of separation components each comprising a truncated hollow conical separation member having an operatively upper inclined separation surface and an operatively lower inclined separation surface, and a plurality of spacers protruding from, and extending along, one of the separation surfaces of the separation member, the spacers being spaced apart about the separation member, with a valley being defined between each spacer and the separation surface and providing a pathway along which, in use, solids can pass, and with the angles at which the pathways are inclined to the horizontal being less than the angle at which the separation surface is inclined to the horizontal, the separation components being located one inside the other so that the spacers of one separation component abut an unencumbered separation surface of an adjacent separation component, the separation members thereby providing an array of parallel inclined separation surfaces, inside the vessel; and
a heavy fraction outlet leading from the vessel below the stack, when the vessel is upright, with the outlet and the separation component stack being arranged such that a feed suspension or mixture which enters the feed inlet zone passes between the separation members and between the spacers located between adjacent pairs of separation members, with separation of the feed suspension or mixture into a light fraction and a heavy fraction taking place under gravity as the suspension or mixture passes between the separation members, and with the light fraction moving upwardly while the heavier fraction moves downwardly and is withdrawn through the heavy fraction outlet.

12. A separator according to claim 11, which includes a light fraction outlet leading from the vessel above the stack, when the vessel is upright.

13. A separator according to claim 11, which includes removal means for removing a light fraction from the surface of a liquid contained in the vessel.

14. A separator according to any one of claims 11 to 13 inclusive, wherein the separation members are imperforate so that solids and liquid passing along the separation surfaces cannot pass through the individual separation members.

15. A separator according to any one of claims 11 to 14 inclusive, wherein the angle at which the separation surfaces of the separation components of the stack are inclined to the horizontal is from 20° to 80°, and wherein the spacers of each component extend from a top edge to a bottom edge of the separation member.

16. A separator according to claim 15, wherein each spacer is in the form of a strip whose thickness is less than the distance it protrudes
from the separation surface, and wherein the spacers protrude perpendicularly from the separation surface.

17. A separator according to any one of claims 11 to 16 inclusive wherein, in respect of each separation component, the spacers are arranged such that the angle at which the pathway of each spacer is inclined to the horizontal has a constant set value along the length of the spacer, with the pathways thus being in the form of at least partial helical spirals.

18. A separator according to claim 15, wherein the separation components are arranged so that the spacers of alternate separation components slope upwardly to the left, when the separation components are viewed in elevation with their axes vertical and their bases, or ends having the largest diameter, lowermost, and with the spacers of the separation components located between said alternate separation components sloping upwards to the right so that the spacers of one separation component cross the spacers of an adjacent separation component at an angle.

19. A separator according to claim 18, wherein each separation component is provided with a sufficient number of spacers, spaced equidistantly about the separation member, so that each spacer of a separation component bears, through a separation member, on at least one spacer of the separation component immediately below it, irrespective of the angular locations of the separation components.

20. A separator according to any one of claims 11 to 19 inclusive, wherein the separation components are located loosely one inside the other.

21. A separator according to any one of claims 11 to 20 inclusive, wherein the separation members are all of the same size so that they are stacked vertically with one separation component bearing the weight of all the superior separation components above it.

22. A separator according to any one of claims 11 to 20 inclusive, wherein the separation members are of differing sizes so that they are located one inside the other in a horizontal sense, with the spacers thus serving to space adjacent separation members apart, to provide rigidity, and to provide bearing for the weight of the inner separation components.

23. A separator according to any one of claims 1 to 22 inclusive, wherein the vessel comprises a normally vertically upright cylindrical wall, and an inverted hollow conical bottom depending from a lower peripheral edge of the wall, with the heavy fraction outlet being provided at the apex of the conical bottom, and with the separation stack being located within the wall and/or the bottom.
